(19) United States
(12) Patent Application Publication
(10) Pub. No.: US 2022/0164611 A1
(43) Pub. Date: May 26, 2022

(54) SYSTEM AND METHOD FOR MULTI-SENSOR, MULTI-LAYER TARGETED LABELING AND USER INTERFACES THEREFOR

(71) Applicant: De-Risking Strategies, LLC, Pflugerville, TX (US)

(72) Inventors: Alex Seguin, Pflugerville, TX (US); Bart Mooyman-Beck, Portland, OR (US); Pushkar Khairnar, Houghton, MI (US); Dara Cline, San Marcos, TX (US); Sheng Xiong Ding, Edmonton (CA)

(21) Appl. No.: 17/456,341

(22) Filed: Nov. 23, 2021

Related U.S. Application Data
(60) Provisional application No. 63/117,291, filed on Nov. 23, 2020.

(51) Int. Cl. G06K 9/62; G06K 9/00; H04N 5/232; H04N 7/18

(52) U.S. Cl. CPC G06K 9/6289; G06K 9/00664; H04N 5/23229; H04N 5/232933; G01S 7/4802; H04N 5/232945; H04N 7/181; G06K 9/6227; G06K 2209/21; H04N 5/23203

(57) ABSTRACT

A method includes receiving an input specifying a recognition target. The method further includes selecting a plurality of models of an initial recognition layer based on the recognition target, and selecting a plurality of models of a final recognition layer based on the recognition target. The method includes obtaining sensor data from two or more sensors of a plurality of sensors, providing the sensor data to the plurality of models of the initial recognition layer to obtain an initial set of identifications, providing sensor data to the plurality of models of the final recognition layer to obtain a final set of identifications, and outputting an identification from at least one of the initial set of identifications or the final set of identifications.

### TECHNICAL FIELD

This application claims priority under 35 U.S.C. § 119(e) to U.S. Provisional Patent Application No. 63/117,291 filed on Nov. 23, 2020. The above-identified provisional patent application is hereby incorporated by reference in its entirety.

This disclosure relates generally to improving the performance, extensibility and security of computing platforms, in particular, edge and standalone computing platforms as tools for implementing labeling, or object recognition of digital data, in particular, digital data from sensors (for example, visual or thermal cameras) connected to the computing platform. More specifically, this disclosure relates to systems and methods for multi-sensor, multi-layer targeted labeling and user interfaces for implementing such methods and systems.

### BACKGROUND

Recent years have seen significant improvements in making machine learning (ML) and model-based labeling, or object recognition, accessible and readily implemented on an ever-expanding variety of computing platforms, such as digital home assistants (for example, AMAZON ECHO® home assistants, smartphones and inexpensive development boards built around low-power internet of things (IoT) processors). However, a significant share of the end devices underpinning the above-described proliferation of ML-enabled functionality operate as pass-throughs for cloud-based analysis platforms (for example, machine learning solutions implemented by AMAZON WEB SERVICES®) constructed around a single, or set ensemble of models. Further consequences of the expansion of ML technology include a growing public awareness of the role of training sets utilizing individuals' data in generating models, and individual and legislative obstacles to obtaining data sets to extend the functionality of existing models. Simply put, many individuals do not want their faces, data or other attributes to be utilized by third parties, and there is a growing body of law to give effect to individuals' preferences regarding their personal data. In practical terms, the expansion of restrictions on the unauthorized use of individual means that extending the functionality of an existing ML by simply obtaining a new, and expanded corpus of training data is becoming an increasingly less viable option.

Thus, the historical paradigm of a single (or limited ensemble) cloud-based model with unfettered access to training data presents a number of performance bottlenecks, and by implication, opportunities for improvement in the art, including, without limitation, improvements in security (for example, by excluding an intrusion path between a user's device and a cloud-based ML platform) and extensibility of ML systems.

### SUMMARY

This disclosure provides systems and methods for multi-sensor, multi-layer targeted labeling and user interfaces for implementing such methods and systems.

In a first embodiment, a method for performing multi-sensor targeted object recognition includes, at an apparatus communicatively connected to a plurality of sensors, receiving an input specifying a recognition target, wherein the recognition target includes at least one higher level attribute of an object providing sensor data. The method further includes selecting a plurality of models of an initial recognition layer based on the recognition target, wherein each model of the initial recognition layer is configured to associate data of a specified sensor with at least one lower level attribute, and selecting a plurality of models of a final recognition layer based on the recognition target, wherein each model of the final recognition layer is configured to associate data of a specified sensor with the at least one higher level attribute. Still further, the method includes obtaining sensor data from two or more sensors of the plurality of sensors, providing the sensor data to the plurality of models of the initial recognition layer to obtain an initial set of identifications, wherein the initial set of identifications includes identifications of objects associated with the at least one lower level attribute, and providing sensor data to the plurality of models of the final recognition layer to obtain a final set of identifications, wherein the final set of identifications comprises identifications of objects associated with the at least one higher level attribute and the at least one lower level attribute. Finally, the method includes outputting an identification from at least one of the initial set of identifications or the final set of identifications.

In a second embodiment, a method of controlling a multi-sensor targeted object recognition includes receiving, via a user interface (UI) of an apparatus communicatively connected to a plurality of sensors, an input specifying a recognition target, wherein the recognition target includes at least one higher level attribute of an object providing sensor data. The method further includes obtaining, by the apparatus, sensor data from two or more sensors of the plurality of sensors, and displaying, at the user interface, a first visualization of sensor data from a first sensor of the plurality of sensors, and a second visualization of sensor data from a second sensor of the plurality of sensors, wherein a field of view of the first visualization of sensor data overlaps with a field of view of the second visualization of sensor data.

In a third embodiment, an apparatus includes a processor, an input/output interface (I/O IF) communicatively connecting the processor to a plurality of sensors, and a memory. The memory contains instructions, which, when executed by the processor, cause the apparatus to receive an input specifying a recognition target, wherein the recognition target includes at least one higher level attribute of an object providing sensor data. When executed by the processor, the instructions further cause the apparatus to select a plurality of models of an initial recognition layer based on the recognition target, wherein each model of the initial recognition layer is configured to associate data of a specified sensor with at least one lower level attribute, select a plurality of models of a final recognition layer based on the recognition target, wherein each model of the final recognition layer is configured to associate data of a specified sensor with the at least one higher level attribute, obtain sensor data from two or more sensors of the plurality of sensors, provide the sensor data to the plurality of models of the initial recognition layer to obtain an initial set of identifications, wherein the initial set of identifications includes identifications of objects associated with the at least one lower level attribute, provide sensor data to the plurality of models of the final recognition layer to obtain a final set of identifications, wherein the final set of identifications includes identifications of objects associated with the at least one higher level attribute and the at least one lower level attribute and output an identification from at least one of the initial set of identifications or the final set of identifications.

In a fourth embodiment, an apparatus includes a processor, an input/output interface (I/O IF) communicatively connecting the processor to a plurality of sensors, and a memory. The memory contains instructions, which, when executed by the processor, cause the apparatus to receive an input specifying a recognition target, wherein the recognition target includes at least one higher level attribute of an object providing sensor data. When executed by the processor, the instructions further cause the apparatus to select a plurality of models of an initial recognition layer based on the recognition target, wherein each model of the initial recognition layer is configured to associate data of a specified sensor with at least one lower level attribute, select a plurality of models of a final recognition layer based on the recognition target, wherein each model of the final recognition layer is configured to associate data of a specified sensor with the at least one higher level attribute, obtain sensor data from two or more sensors of the plurality of sensors, provide the sensor data to the plurality of models of the initial recognition layer to obtain an initial set of identifications, wherein the initial set of identifications includes identifications of objects associated with the at least one lower level attribute, provide sensor data to the plurality of models of the final recognition layer to obtain a final set of identifications, wherein the final set of identifications includes identifications of objects associated with the at least one higher level attribute and the at least one lower level attribute and output an identification from at least one of the initial set of identifications or the final set of identifications.

In a fifth embodiment, a non-transitory computer-readable medium includes instructions, which when executed by a processor, cause an apparatus having the processor, an input/output interface (I/O IF) communicatively connecting the processor to a plurality of sensors, to receive an input specifying a recognition target, wherein the recognition target comprises at least one higher level attribute of an object providing sensor data. When executed by the processor, the instructions further cause the apparatus to select a plurality of models of an initial recognition layer based on the recognition target, wherein each model of the initial recognition layer is configured to associate data of a specified sensor with at least one lower level attribute, select a plurality of models of a final recognition layer based on the recognition target, wherein each model of the final recognition layer is configured to associate data of a specified sensor with the at least one higher level attribute, obtain sensor data from two or more sensors of the plurality of sensors, provide the sensor data to the plurality of models of the initial recognition layer to obtain an initial set of identifications, wherein the initial set of identifications comprises identifications of objects associated with the at least one lower level attribute, provide sensor data to the plurality of models of the final recognition layer to obtain a final set of identifications, wherein the final set of identifications comprises identifications of objects associated with the at least one higher level attribute and the at least one lower level attribute, and output an identification from at least one of the initial set of identifications or the final set of identifications.

In a sixth embodiment, a non-transitory computer-readable medium contains instructions, which when executed by a processor of an apparatus including an input/output interface (I/O IF) communicatively connecting the processor to a plurality of sensors and a display for providing a graphical user interface, cause the apparatus to receive, via the graphical user interface, an input specifying a recognition target, wherein the recognition target comprises at least one higher level attribute of an object providing sensor data, obtain sensor data from two or more sensors of the plurality of sensors; and display, at the graphical user interface, a first visualization of sensor data from a first sensor of the plurality of sensors, and a second visualization of sensor data from a second sensor of the plurality of sensors, wherein a field of view of the first visualization of sensor data overlaps with a field of view of the second visualization of sensor data.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. Further examples of non-transitory computer-readable medium include, without limitation, removable support media for development boards, such as MicroSD cards. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of an apparatus according to some embodiments of this disclosure;

FIG. 2 illustrates an example of an architecture for implementing a multi-sensor, multi-layer targeted object recognition according to certain embodiments of this disclosure;

FIG. 3 illustrates an example of an ensemble of machine learning (ML) models and a processing flow for performing a multi-sensor, multi-layer targeted object recognition according to various embodiments of this disclosure;

FIGS. 4-7 illustrate examples of graphical user interfaces for controlling and receiving outputs from multi-sensor targeted object recognition operations according to various embodiments of this disclosure;

FIG. 8 illustrates operations of an example method for performing a targeted multi-sensor, multi-layer object recognition according to various embodiments of this disclosure;

FIG. 9 illustrates operations of an example method for providing a GUI for controlling and receiving outputs of a multi-sensor targeted object recognition according to some embodiments of this disclosure;

FIG. 10 illustrates an example architecture of a modular, autonomous vehicle platform according to various embodiments of this disclosure; and

FIG. 11 illustrates an example of an autonomous vehicle performing object-recognition based navigation according to various embodiments of this disclosure negotiating a course.

### DETAILED DESCRIPTION

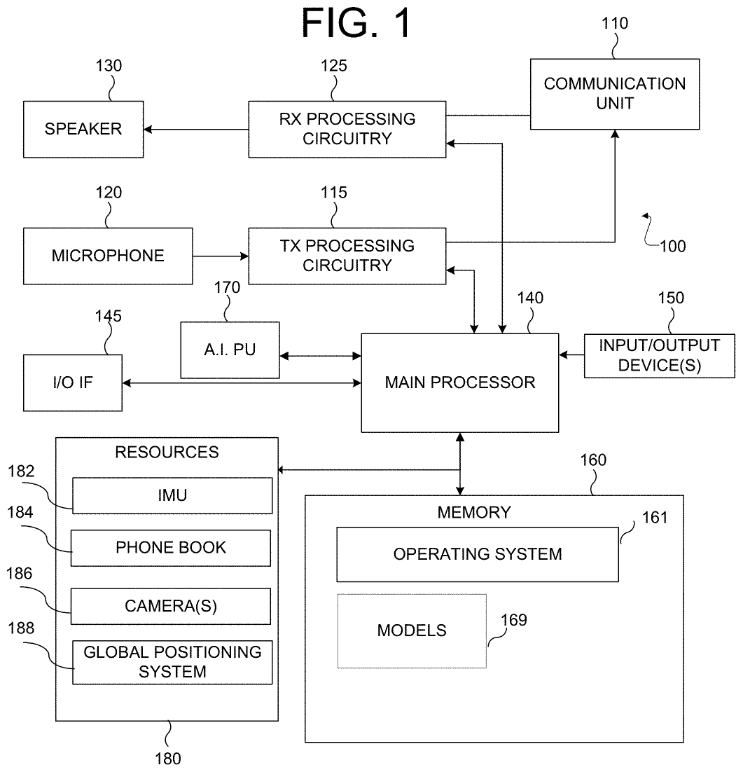

FIGS. 1 through 11, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably configured processing platform.

FIG. 1 illustrates one example of an apparatus 100 according to certain embodiments of this disclosure. The embodiment of apparatus 100 illustrated in FIG. 1 is for illustration only, and other configurations are possible. However, suitable devices come in a wide variety of configurations, and FIG. 1 does not limit the scope of this disclosure to any particular implementation of an apparatus.

As shown in FIG. 1, the apparatus 100 includes a communication unit 110 that may include, for example, a radio frequency (RF) transceiver, a BLUETOOTH® transceiver, or a Wi-Fi® transceiver, etc., transmit (TX) processing circuitry 115, a microphone 120, and receive (RX) processing circuitry 125. The apparatus 100 also includes a speaker 130, a main processor 140, an input/output (I/O) interface (IF) 145, input/output device(s) 150, and a memory 160. The memory 160 includes an operating system (OS) program 161, and one or more models 169. According to various embodiments, external sensors can connect communicatively to main processor 140 through I/O IF 145. Examples of external sensors which can connect to main processor 140 through I/O IF 145 include, without limitation, complementary metal oxide semiconductor (CMOS) image sensors, dynamic vision sensors (DVS), infrared (IR) imaging sensors, light detection and ranging (LIDAR) scanners, ultraviolet (UV) imaging sensors, time of flight (TOF) sensors, stereoscopic cameras, and acoustic sensors, including single microphones, as well as arrays of acoustic sensors. Examples of arrays of acoustic sensors according to certain embodiments include, without limitation, acoustic imaging arrays, such as the CAM64 acoustic camera by Sorama Corporation.

The communication unit 110 may receive an incoming RF signal, for example, a near field communication signal such as a BLUETOOTH® or WI-FI® signal. According to certain embodiments, communication unit 110 supports one or more protocols utilized in 5G communications networks. The communication unit 110 can down-convert the incoming RF signal to generate an intermediate frequency (IF) or baseband signal. The IF or baseband signal is sent to the RX processing circuitry 125, which generates a processed baseband signal by filtering, decoding, or digitizing the baseband or IF signal. The RX processing circuitry 125 transmits the processed baseband signal to the speaker 130 (such as for voice data) or to the main processor 140 for further processing (such as for web browsing data, online gameplay data, notification data, or other message data). According to some embodiments, RX processing circuitry 125 supports communications on 5G wireless networks, or other media supporting fast (i.e., 100 MB/s) or faster communication rates.

The TX processing circuitry 115 receives analog or digital voice data from the microphone 120 or other outgoing baseband data (such as web data, e-mail, or interactive video game data) from the main processor 140. The TX processing circuitry 115 encodes, multiplexes, or digitizes the outgoing baseband data to generate a processed baseband or IF signal. The communication unit 110 receives the outgoing processed baseband or IF signal from the TX processing circuitry 115 and up-converts the baseband or IF signal to an RF signal for transmission. According to some embodiments, TX processing circuitry 115 supports communications on 5G wireless networks, or other media supporting fast (i.e., 100 MB/s) or faster communication rates.

In certain embodiments, communication unit 110, and one or more of TX processing circuitry 115 or RX processing circuitry 125 can be omitted or selectively disabled, and apparatus 100 can selectively operate as an edge device or a standalone device, rather than as a portal for cloud-based service. As used in this disclosure, the expression “edge device” encompasses a device which does not require communication over a network connection to provide data to one or more (ML) models. According to some embodiments, an “edge device” can be otherwise connected to a network. In this way, the security of operations at apparatus 100 can, if desired, be enhanced by reducing the opportunities for malicious actors to tamper with models 169 or other data maintained at apparatus 100.

The main processor 140 can include one or more processors or other processing devices and execute the OS program 161 stored in the memory 160 in order to control the overall operation of the apparatus 100. For example, the main processor 140 could control the reception of forward channel signals and the transmission of reverse channel signals by the communication unit 110, the RX processing circuitry 125, and the TX processing circuitry 115 in accordance with well-known principles. In some embodiments, the main processor 140 includes at least one microprocessor or microcontroller.

The main processor 140 is also capable of executing other processes and programs resident in the memory 160. The main processor 140 can move data into or out of the memory 160 as required by an executing process. In some embodiments, the main processor 140 is configured to execute the applications 162 based on the OS program 161 or in response to inputs from a user or applications 162. Applications 162 can include applications specifically developed for the platform of apparatus 100, or legacy applications developed for earlier platforms. The main processor 140 is also coupled to the I/O interface 145, which provides the apparatus 100 with the ability to connect to other devices such as laptop computers and handheld computers. The I/O interface 145 is the communication path between these accessories and the main processor 140.

The main processor 140 is also coupled to the input/output device(s) 150. The operator of the apparatus 100 can use the input/output device(s) 150 to enter data into the apparatus 100. Input/output device(s) 150 can include keyboards, touch screens, mouse(s), track balls or other devices capable of acting as a user interface to allow a user to interact with apparatus 100. In some embodiments, input/output device(s) 150 can include a touch panel, a virtual reality headset, a (digital) pen sensor, a key, or an ultrasonic input device. Additionally, input/output devices 150 can include external sensors communicatively coupled, either through a physical, or wireless connection to apparatus 100.

Input/output device(s) 150 can include one or more screens, which can be a liquid crystal display, light-emitting diode (LED) display, an optical LED (OLED), an active matrix OLED (AMOLED), or other screens capable of rendering graphics.

The memory 160 is coupled to the main processor 140. According to certain embodiments, part of the memory 160 includes a random access memory (RAM), and another part of the memory 160 includes a Flash memory or other read-only memory (ROM). In the non-limiting example of FIG. 1, memory 160 includes one or more models 169. In certain embodiments, models 169 comprise pretrained deep learning models. Depending on the storage capacity, processing power, and operational expectations (for example, battery life, operating temperature and so forth) of apparatus 100, models 169 may comprise lightweight versions of deep learning models.

Although FIG. 1 illustrates one example of an apparatus 100. Various changes can be made to FIG. 1. For example, according to certain embodiments, apparatus 100 can further include a separate artificial intelligence processing unit 170 (AI PU), such as a GOOGLE® Coral board or accelerator or other processor, such as a graphics processing unit. adapted to process heavily multithreaded processing applications. Further examples of hardware suitable for use as AI PU 170 include, without limitation, the NVIDIA JETSON and XAVIER.

According to certain embodiments, apparatus 100 includes a variety of additional resources 180 which can, if permitted, be accessed by main processor 140. According to certain embodiments, resources 180 include an accelerometer or inertial motion unit 182, which can detect movements of the electronic device along one or more degrees of freedom. Additional resources 180 include, in some embodiments, a user's phone book 184, one or more cameras 186 of apparatus 100, and a global positioning system 188.

Although FIG. 1 illustrates one example of an apparatus 100 for implementing monitoring of suspicious application access, various changes may be made to FIG. 1. For example, the apparatus 100 could include any number of components in any suitable arrangement. In general, devices including computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

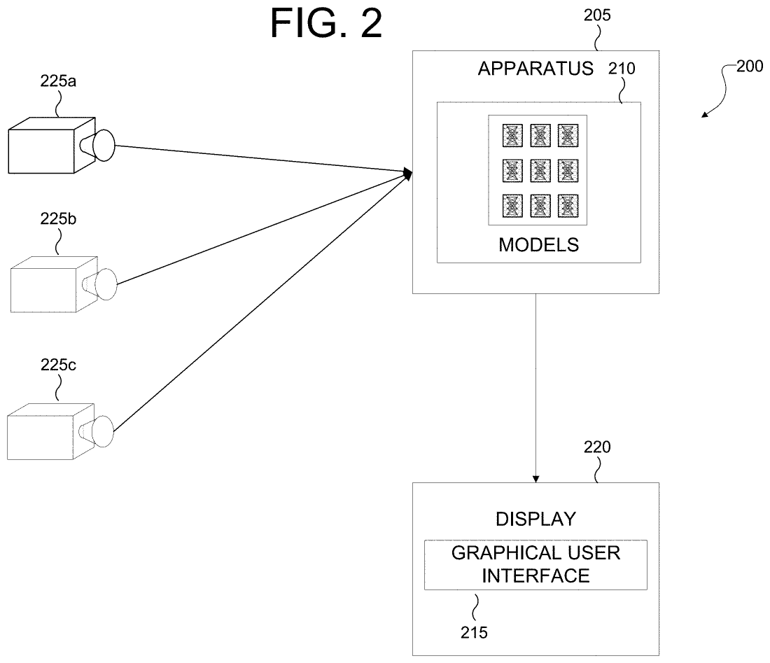

FIG. 2 illustrates one example of an architecture 200 for implementing multi-sensor, multi-layer targeted labeling and user interfaces for implementing such methods and systems according to certain embodiments of this disclosure.

Referring to the non-limiting example of FIG. 2, architecture 200 comprises at least one apparatus 205 (for example, apparatus 100 in FIG. 1). According to certain embodiments, apparatus 205 is a computing platform which can implement a plurality of models 210, and is communicatively connected to a plurality of sensors (shown in FIG. 2 as sensors 225a, 225b and 225c), and is further connected to a display 220 providing graphical user interface 215. In some embodiments, each of sensors 225a through 225c are cameras, which may be configured to collect visual data from different perspectives (for example, as a stereoscopic pair) or across different portions of the electromagnetic spectrum (for example, visible light and infrared). However, embodiments according to this disclosure are not so limited, and include embodiments in which some or all of sensors 225a through 225c are non-optical sensors, such as acoustic sensors. Simply put, embodiments of architecture 200 encompass embodiments where the input data is provided by visual sensors (for example, cameras), non-visual sensors (for example, microphones) and combinations thereof.

In certain embodiments, apparatus 205 is an edge device which can connected, for example, through a WI-FI® or LTE connection, to one or more other networks or devices. In some embodiments, apparatus 205 can be configured to operate as a standalone (i.e., not networked to other processing platforms) either permanently or temporarily (for example, through user configuration disabling a network connection).

According to various embodiments, the plurality of sensors (including sensors, 225a, 225b, and 225c) are connected to apparatus through one or more of a physical communication medium (for example, a cable or bus), or a wireless communication medium (for example, a BLUETOOTH® link).

According to various embodiments, models 210 comprise an ensemble of machine learning (ML) models, wherein models 210 comprises a set of models (for example, neural network models), each of which is configured to receive, as inputs data from at least one sensor of the plurality of sensors, and assign a label to one or more objects or source of features within the input data set, along with a confidence interval or other quantification of the predicted accuracy of the assigned label. As a non-limiting example, consider the case where sensor 225a is a thermal imaging camera, one model of models 210 may output a vector comprising labels and confidence scores to heat signatures obtained by sensor 225a. Thus, for a hypothetical exothermal object from which sensor data has been obtained by sensor 225a, the model may output a vector labeling the object as a “horse” with 60% confidence, as “cow” with a 30% confidence interval. Further, apparatus 205 contains a schema or other data structure mapping the inputs and outputs of each model of models 210 to sensors of the plurality of sensors and a plurality of recognition targets. Additionally, in certain embodiments where the sensor input from sensors 225a-225c includes audio sensor, one model of models 210 may output a vector comprising labels and confidence scores assigned to an audio signature (for example, a voice sample) received by sensor 225a.

As used in this disclosure, the expression “recognition target” encompasses one or end states of a labelling process, wherein the end states are further associated with a higher, or top-level attribute label in a taxonomy of labels of the end state.

As one non-limiting example, consider an embodiment of architecture 200, wherein sensors 225a and 225b are visual cameras disposed at two different viewing angles and sensor 225c is a thermal, or IR imaging camera. In this example, the recognition target is an identification of a person. That is, the end state is a label associated with a person, (e.g., “John Smith”). In addition to one or more models that can specifically associate at least one strain of sensor data (for example, CMOS image sensor data) with “John Smith,” apparatus 205 maintains a taxonomy of labels associated with the end state label “John Smith.” For example, the taxonomy of labels associated with “John Smith” may include labels associated with labels which can be output by one or more models of models 210 which utilize data from a thermal sensor, such as “mammal,” “human,” and “exotherm.” The taxonomy of labels may further include lower-level labels which can be output by one or more models of models 210 which can output the end state label “John Smith,” such as “human” or “head.” In this way, architecture 205 can label sensor data with greater confidence than single-sensor, single model architectures. In the example of identifying “John Smith” based on optical and thermal imaging, certain embodiments according to this disclosure can avoid false positives (for example, identifications based on seeing a photo of “John Smith”) to which single-sensor, single model systems are susceptible. Put differently, architecture 200 can provide more robust performance than certain systems embodying historical ML labeling paradigms.

Referring to the explanatory example of FIG. 2, architecture 200 includes one or more displays 220. In some embodiments, display 220 is integral with apparatus 205 (for example, where apparatus 205 is a tablet computer). In other embodiments, display 220 is a standalone display device (for example, a device with a touchscreen display) connected through either a physical medium (i.e., a cable) or wireless connection to apparatus 205. Display 220 is configured to provide at least one graphical user interface 215 for controlling through which a user can control apparatus 205 and receive outputs from the plurality of sensors and ML analyses performed at apparatus 205.

As noted elsewhere in this disclosure, the technical challenges associated with ML-enabled object recognition include, without limitation, improving the robustness of recognition determinations (for example, not being spoofed by photos or other inanimate representations of a human recognition target), and achieving extensibility in the face of potential training data scarcity. With the advent of, for example, the General Data Protection Regulation (“GDPR”) in the European Union, it is unreasonable, at least in certain jurisdictions, to assume that the large corpuses of data necessary to train and extend existing ML models will be automatically available. Simply put, the future challenges in ML appear almost certain to include being able to do more with existing models, rather than operating on the expectation of being able to grow an existing model with fresh data. Further to this point, as computing continues its general shift away from desktop computers towards smaller, battery-powered computing, the technical challenges in implementing ML-enabled recognition also include reducing processor load, and by implication, battery consumption.

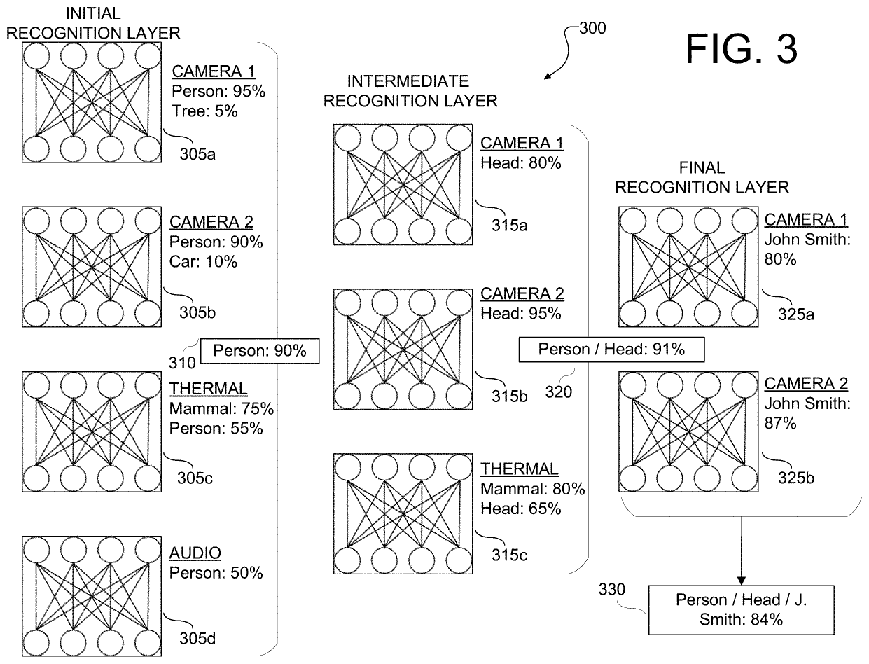

FIG. 3 illustrates aspects of one example of multi-model, multi-sensor targeted labeling according to some embodiments of this disclosure. As discussed with reference to the example of FIG. 3, embodiments according to this disclosure address the above-described technical challenges and offer improvements in the effectiveness of computing platforms as tools for ML-enabled recognition applications, as well as ways to improve the extensibility of ML-enabled recognition systems without relying on an abundance of new training data. Further, as discussed herein, certain embodiments according to this disclosure can selectively process sensor data, thereby reducing consumption of processor, and by implication, battery resources.

Referring to the non-limiting example of FIG. 3, an ensemble of models 300 for performing a multi-layer, multi-sensor object identification according to some embodiments of this disclosure is shown in the figure. In this example, ensemble 300 comprises models (305a, 305b, 305c, and 305d) of an initial recognition layer, models (315a, 315b, and 315c) of an intermediate recognition layer, and models (325a and 325b) of a final recognition layer. In this example, the models of ensemble 300 of each of the initial, intermediate and final recognition layers are selected based on a defined recognition target. According to various embodiments, the models of the initial, intermediate and final recognition layers of ensemble 300 operate as a logical funnel for a recognition process that initially identifies data having general features of the recognition target in the initial recognition layer, then performs one or more recognitions of data associated with more specific attributes of the recognition target in the intermediate recognition layer(s), and then zeroes in on candidate sets of data comprising the recognition target in the final recognition layer. In this way, ensemble 300 provides a framework for targeted object recognition which combines robust performance (i.e., the outcome of the analysis is not dependent on a single sensor/model pairing), readily extensible (i.e., more models can be added to the corpus of models from which an ensemble of models is selected), and efficient (i.e., with multiple models available, models reliant on energy hungry sensors can, if desired, be excluded from an ensemble of models).

The models of ensemble 300 are maintained on an apparatus (for example, apparatus 100 in FIG. 1 or apparatus 205 in FIG. 2) which is connected to a plurality of sensors, including a pair of visual cameras, a thermal camera, and a dynamic vision sensor. Depending on embodiments, the models of ensemble 300 may be trained at the apparatus, or separately pre-trained and loaded onto the apparatus. Further models of ensemble 300 may include publicly available models (for example, models freely available at www.tensorflow.org), as well as purpose-specific or proprietary models (for example, models trained by end users to recognize specific individuals of interest).

In this example, the recognition target is an identification of an object in the set of objects which includes the human “John Smith.” In some embodiments, apparatus implementing ensemble of models 300 maintains a schema, taxonomy or other data structure of labels which can be identified by models of ensemble of models 300, and which are related to the recognition target “John Smith.” Examples of labels related to “John Smith” in the schema, taxonomy or other data structure might include “person,” recognizable parts of a person (i.e., head, arms, torso), as well as characteristic labels (for example, “exotherm,” “moving,” or “not moving.”). According to various embodiments, the recognition target is specified through an input provided to the apparatus, such as, an input provided through a graphical user display of the apparatus (for example, graphical user interface 215 in FIG. 2).

Referring to the non-limiting example of FIG. 3, the models of the initial recognition layer are selected by the apparatus from a superset of available models on the apparatus (for example, models 210 in FIG. 2 or models 169 in FIG. 1). According to some embodiments, the models of the initial recognition layer are selected from a predetermined set of models associated with one or more lower level attributes of the recognition target. As used in this disclosure, the expression “lower level attribute” comprises one or more labels in a taxonomy of labels associated with the recognition target specifying an attribute of the recognition target, but which is not exclusive to the recognition target. Thus, in this example, if the label “John Smith” is a higher or top level label in the taxonomy of labels associated with “John Smith” as a recognition target, attributes of “John Smith” within the taxonomy of labels, such as “mammal” or “person” would be examples of lower-level attributes.

In some embodiments, the models of the initial recognition layer are chosen based on the recognition target in combination one or more factors, such as contextual or system factors. Examples of a contextual factor include, without limitation, the time of day, in particular, whether it is daytime or nighttime. Where the presence of daylight is a contextual factor, models taking inputs from natural light cameras may be excluded from the initial recognition layer, or models which rely on daylight-independent inputs, such as the outputs from a LIDAR scanner or thermal camera, may be selected for inclusion within the initial recognition layer. Examples of systems factors include, without limitation, the power available to the apparatus (for example, whether the apparatus is operating from a DC power source, or a mostly depleted battery), the sensors currently connected to the apparatus, and combinations thereof. For example, if the system factors show that the apparatus is operating in a battery powered mode, and certain sensors may exhaust the available power resources before making a determination, the models of the initial recognition layer may be selected to comprise models whose inputs utilize lower-power sensors.

As shown in the illustrative example of FIG. 3, the models of the initial recognition layer comprise model 305a, whose inputs comprise data taken from a first visual camera (“CAMERA 1”), and whose outputs include confidence weighted labels of lower-level attributes of the recognition target, including a label showing with 95% confidence that the data obtained by first visual camera includes image data of a person. In this example, the models of the initial recognition layer further comprise model 305b, whose inputs comprise data taken from a second visual camera (“CAMERA 2”), and whose outputs include confidence weighted labels associated with lower-level attributes of the recognition target, such as a label showing, with 90% confidence, that data obtained by the second visual camera includes image data of a person. According to certain embodiments, the first and second visual cameras are trained on overlapping fields of view and comprise a stereoscopic imaging sensor whose combined data can be used for depth estimation and refining focus of other sensors connected to the apparatus.

Referring to the non-limiting example of FIG. 3, the models of the initial recognition layer further comprise model 305c, whose inputs comprise data taken from a thermal camera, and whose outputs comprise confidence weighted labels of lower level attributes of the recognition target, including, for example a label showing, with 75% confidence that the data from the thermal camera shows a “mammal”. Finally, in this example, the models of the initial recognition layer comprise model 305d, which is configured to take as inputs, an event stream from an audio sensor and output confidence weighted labels of lower level attributes of the recognition target, including, for example, a label showing, with 50% confidence that the data stream from the audio sensor includes data from a person.

According to certain embodiments, sensor data from the respective sensors connected to the apparatus is fed to the respective models of the initial recognition layer to obtain a set of confidence weighted labels from which a composite confidence weighted label 310 is obtained. In some embodiments, the composite confidence weighted label is a simple weighted average of the highest weighted labels from each of the models of the initial recognition layer. In various embodiments, the weights to be given to the various outputs of the models of the initial recognition layer are tunable parameters, which can be adjusted in response to contextual, system and historical factors. For example, when one model's output (for example, model 305d's) outside of a standard deviation of the output of other models, its contribution to the composite confidence weighted label output by the initial recognition layer. In this example, a DVS sensor, is, by design, configured to catch changes in the appearance of a scene. Thus, if a subject stays silent, an audio sensor may not capture much, if any, reliable data to be fed to a model.

Referring to the non-limiting example of FIG. 3, in some embodiments, ensemble of models 300 further comprises an intermediate recognition layer comprising a set of models selected by the apparatus from a superset of available models on the apparatus (for example, models 210 in FIG. 2 or models 169 in FIG. 1). According to some embodiments, the models of the intermediate recognition layer are selected from a predetermined set of models associated with one or more intermediate level attributes of the recognition target. As used in this disclosure, the expression “intermediate level attribute” comprises one or more labels in a taxonomy of labels associated with the recognition target specifying an attribute of the recognition target which is neither exclusive to the recognition target, or a lower-level attribute of the recognition target. As the name rightly suggests, an intermediate level attribute occupies a tier below a high level attribute and above the low level attributes of the recognition target within a taxonomy of labels associated with the target. By way of explanatory example, if the individual “John Smith” is a high-level attribute of the recognition target, and “person” is a low-level attribute of the recognition target (i.e., “John Smith” is a person), then intermediate-level attributes would include attributes of people, which are also associated with “John Smith,” such as “male” or body parts, such as “head” or “torso.” Depending on embodiments, there may be overlap between labels which can be output by models of the initial recognition layer and the intermediate recognition layer.

According to certain embodiments, the apparatus performing multi-layer multi-sensor targeted objection recognition selects models (for example, models 315a, 315b and 315c) based on the recognition target, and in particular, models which can output labels associated with intermediate level attributes of the recognition target.

In some embodiments, the apparatus selects the models of the intermediate recognition layer based exclusively upon the application of a predetermined rule to the specified recognition target. In certain embodiments, the apparatus selects the models of the intermediate recognition layer based on the recognition target and at least one further parameter, including without limitation, a factor associated with a contextual parameter, a system parameter, or the outputs of models in the initial recognition layer. For example, in some embodiments, where one or more models of the initial recognition yield outputs that are out of line, either in terms of the label assigned or the confidence level achieved (such as model 305d), the apparatus may select the models of the intermediate recognition layer such that models using the same inputs as models of the initial recognition layer which produced underperforming results are excluded from the intermediate recognition layer.

Referring to the illustrative example of FIG. 3, sensor data for each of the models of the intermediate recognition layer is fed to each of the models of the intermediate recognition layer. In some embodiments, to reduce the processing load, the sensor data fed to the models of the intermediate recognition layer is a subset of the available subset of data from the sensors associated with the selected models. In some embodiments, the sensor data to be fed to models of the intermediate recognition layer is determined based on the output(s) of models of the initial identification layer. For example, model 315a may, in some embodiments, only analyze the data from the first visual camera in which model 305a identified data labeled as “person.” In this way, the performance of the apparatus is improved, both in terms of processing speed and processing efficiency, in that further processing of sensor data which was found to not contain labelable content can be avoided.

According to certain embodiments, the models of intermediate recognition layer include model 315a, whose inputs include at least part of the available sensor data from the first visual camera, and whose outputs comprise confidence weighted labels associated with intermediate level attributes of the recognition target. In the example of FIG. 3, model 315a's output comprise a determination, with an 80% confidence interval, that image data from the first visual camera includes a head.

In some embodiments, the models of the intermediate recognition layer further include model 315b, whose inputs include part, or all, of the available sensor data from the second visual camera, and whose outputs comprise confidence weighted labels associated with intermediate level attributes of the recognition target. For example, in the example of FIG. 3, the outputs of model 315b include labeling, with a 95% degree of confidence, a portion of the sensor data as containing a head. In certain embodiments, the selection of data containing the labeled objects is determined according to common parameters across models, such that for a given recognized object, proportionally similar “boxes” of sensor data are drawn around the recognized object. In this way, the outputs of the ML models of ensemble 300 can be applied to perform range finding, parallax correction and other multi-perspective image processing tasks.

As shown in the illustrative example of FIG. 3, the models of the intermediate recognition layer also include model 315c, whose inputs comprise sensor data from a thermal image camera, and whose outputs comprise confidence weighted labels associated with intermediate level attributes of the recognition target found in the sensor data. In this example, the outputs of model 315c include a confidence weighted label showing that some subset of the sensor data from the thermal camera contains, at an 80% confidence level, a mammal, and at a 65% confidence level, a human head.

According to various embodiments, the intermediate recognition layer outputs a composite weighted label 320 based on the outputs obtained by feeding sensor data to the constituent models of the intermediate recognition layer. As shown in FIG. 3, in some embodiments, composite weighted label 320 is a composite of labels associated with one or more attributes of the recognition target (for example, “person” and “head”) as well as a composite confidence interval for the composite label. In some embodiments, the composite interval is determined as a straight weighted average of the confidence weights output by each model of the intermediate recognition layer. In various embodiments, the weightings to be given to each model are tunable parameters, which can be adjusted based on one or more of contextual factors, system factors and the performance of specific models.

Referring to the non-limiting example of FIG. 3, ensemble 300 further comprises a final recognition layer, comprising a selected set of models (325a, 325b) whose outputs include one or more labels associated with higher-level attributes of the recognition target. As used herein, the expression “higher level attribute” encompasses one or more labels to support a determination of whether the specified recognition target is in the collective field of view of the sensors to which the apparatus is connected. In the non-limiting example of FIG. 3, lower and intermediate level attributes such as “person,” “head” and “mammal” can focus the analysis performed by the apparatus and rule out false positives in the final recognition layer (for example, sensor data that contains the face of “John Smith,” but which fails to include other attributes of “John Smith,” such as being a “person” or a heat signature associated with “mammal), while the higher-level attribute is necessarily present in the recognition target (for example, image data of “John Smith's” face).

According to certain embodiments, the apparatus selects the models of the final recognition layer based at least in part on the specified recognition target. In some embodiments, the models are selected from a set of models which can output labels associated with one or more higher level attributes of the recognition target, in conjunction with one or more contextual factors, system factors, and indicia of the performance of other sensor/model combinations in ensemble 300.

Each model of the final recognition layer is fed an input set of sensor data from the sensor(s) associated with that model. In some embodiments, to enhance efficiency and overall performance, the sensor data provided to models of the final recognition layer comprises a targeted subset of the available sensor data, wherein the targeted subset is selected based on the output of one or more models of the initial recognition layer or intermediate layer. For example, where model 315b has identified data showing a subject's head in the sensor data from visual camera 2, only the data associated with the subject's head is fed to model 325b of the final recognition layer.

As shown in FIG. 3, the models of the final recognition layer comprise model 325a, whose inputs comprise sensor data from the first visual camera, and whose outputs comprise confidence weighted labels, including labels associated with a higher level attribute. In this example, model 325a outputs a confidence weighted label of “John Smith,” with an 80% confidence weighting.

The models of the final recognition layer further comprise model 325b, whose inputs comprise sensor data from the second visual camera, and whose outputs comprise confidence weighted labels associated with one or more higher level attributes of the recognition target. In this example, model 325b outputs a confidence weighted label of “John Smith” with a confidence score of 87%.

Referring to the illustrative example of FIG. 3, the apparatus generates a final composite confidence weighted label 330 based at least in part on the confidence weighted labels output by each of the models of the final recognition layer. According to certain embodiments, final composite confidence weighted label 330 is determined as a simple weighted average of the outputs of each of the models of the final recognition layer. In some embodiments, the weights assigned to the outputs of each model are, for the final recognition layer, as with the initial recognition layer and intermediate recognition layer(s), themselves tunable parameters, which can be adjusted to account for, without limitation, sensor performance, contextual factors and system factors. Additionally, in some embodiments, the values of composite confidence weighted labels 310 and 320 may affect the confidence value of final composite confidence weighted label 330. For example, suppose the models of the final recognition layer confidently recognize the face of “John Smith” in the image data, but the models of the initial and intermediate recognition layers provide less confident identifications of the lower-and-intermediate level attributes of “John Smith” (for example, detecting a “person” in the image data, or finding thermal camera evidence of a warm blooded object), the confidence score provided by final composite confidence weighted label 330 may, in some embodiments, be discounted to reflect the inconsistency in the confidence levels of the outputs of the final recognition layer relative to the intermediate and initial recognition layers. In this way, certain embodiments according to this disclosure allow the concatenation of multiple existing models to extend the performance of an ML identification system. Further, the concatenation of models described with reference to the example of FIG. 3 can, in certain embodiments, enable a system with multiple sensors and a multi-layer ensemble of lower-end (for example, open-source or trained on smaller data sets) models to outperform systems utilizing a single sensor and more extensively trained models.

According to various embodiments, ensemble 300 can be implemented with performance-based control logic between the initial, intermediate and final recognition layers, thereby improving the efficiency and robustness with which the system performs object recognitions. In some embodiments, the control logic comprises, implementing for each model of the initial recognition layer, a confidence threshold and an agreement requirement before sensor data can be fed to models of the intermediate and final recognition layers. As one example, each model of the initial recognition layer of ensemble 300 needs to output a label with a confidence interval of 50% or greater on the same label. Unless this criterion is achieved, no data is provided to the intermediate and higher recognition layers. In some embodiments, each layer of ensemble 300 has confidence threshold and agreement parameters controlling whether sensor data is provided to the next recognition layer of the ensemble. In this way, the risk of the final output 330 of ensemble 300 comprising a false positive can be tuned according to the user's requirements.

While FIG. 3 provides an explanatory example of multi-layer, multi-layer targeted object recognition in the context of a three layer system where the recognition target comprises recognition of a person (i.e., is “John Smith” in the sensor data), embodiments according to this disclosure are not so limited. For example, in some embodiments, the recognition target may comprise a plurality of higher level attributes, such as whether an object labeled as a gun can be found in the sensor data, and further, whether the object labeled as a gun providing visual, thermal or other indicia of a recently fired state. Further, in some embodiments, ensemble 300 may comprise only an initial recognition layer and a final recognition layer. Alternatively, in certain embodiments, ensemble 300 may comprise more than one intermediate recognition layer.

Further, while the illustrative example of FIG. 3 has been described with reference to an ensemble 300 of models which take as their inputs, the outputs of audio sensors and image sensors, embodiments according to this disclosure are not so limited, and the underlying disclosure of a layered ensemble of machine trained models producing a recognition output at a final recognition layer is equally applicable to machine trained models whose input features comprise other types of data, such as time of flight (TOF) or depth sensor data.

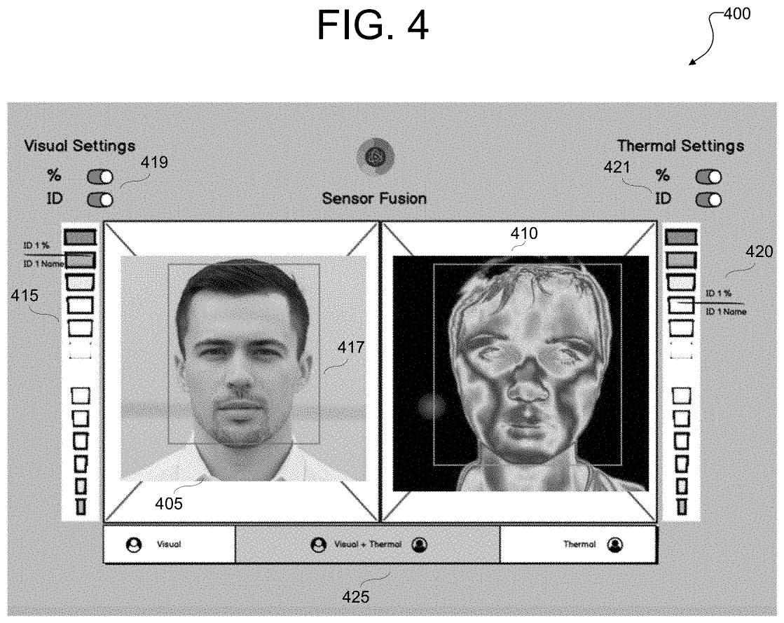

FIG. 4 illustrates an example of a graphical user interface (GUI) 400 for providing control inputs and receiving outputs of a targeted object recognition system. According to certain embodiments, GUI 400 is provided on a display (for example, display 220 in FIG. 2) which is communicatively connected to an apparatus (for example, apparatus 205 in FIG. 2 or apparatus 100 in FIG. 1) implementing multi-sensor targeted object recognition according to various embodiments of this disclosure. In the illustrative example of FIG. 4, the apparatus supporting GUI 400 is communicatively connected to a plurality of sensors, including at least one visual camera, and one thermal camera.

Referring to the non-limiting example of FIG. 4, GUI 400 comprises a display screen which includes a first visualization 405 of sensor data obtained by a first sensor communicatively connected to the apparatus. In this particular example, first visualization 405 comprises a feed of camera data output by a first visual camera (for example, a digital camera with a CMOS image sensor). According to certain embodiments, GUI 400 further comprises a second visualization 410 of sensor data obtained by a second sensor communicatively connected to the apparatus supporting GUI 400. In this non-limiting example, second visualization 410 comprises a feed of thermal camera data from a thermal camera communicatively connected to the apparatus supporting GUI 400. In this illustrative example, the field of view of the visual camera providing the sensor data for first visualization 405 and the field of view of the thermal camera providing the sensor data for second visualization 410 overlap, as shown by the presence of the subject's head in both visualizations.

As shown in the illustrative example of FIG. 4, GUI 400 further comprises a first visualization 415 of a confidence score associated with an ML-enabled recognition operation (for example, a confidence weighted label provided by a model of ensemble 300 in FIG. 3) performed by the apparatus. In this example, first visualization 415 comprises qualitative representation (as shown by a stack of colored amplitude bars) of the confidence with which the recognition target has been identified in the sensor data from one or more models of an ensemble of models implemented by the apparatus. First visualization 415 can also comprise a quantitative and textual representation (shown as “ID 1%” and “ID 1 Name”) in the figure, of the confidence score associated with the at least one higher level attribute. According to certain embodiments, first visualization 415 also comprises a bounding box 417 showing the subset of the sensor data supporting the recognition of the higher-level attribute. In this example, the recognition target is a particular individual, and bounding box 417 shows identifies, the subject's head as supporting the identification. In some embodiments, the definition of bounding boxes is normalized across models, and the bounding boxes output by different models can be used, without limitation, to estimate depth and refine the focus of sensors of the plurality of sensors.

Referring to the non-limiting example of FIG. 4, GUI 400 likewise includes one or more controls 419 for adjusting parameters of first visualization 415. For example, controls 419 include slider switches for disabling the quantitative representation of the confidence interval, and for turning bounding box 417 on and off.

Similarly, GUI 400 comprises a second visualization 420 of the confidence score associated with an ML-enabled recognition operation (for example, a confidence weighted label provided by a model of ensemble 300 in FIG. 3) performed by the apparatus based on the sensor data from the thermal camera. As with the first visualization 415 of the confidence of the labeling based on the sensor data from the visual camera, second visualization 420 is provided both qualitatively (again, as a stack of color coded amplitude bars) and quantitatively (again, as an identifier of the name of the recognition target, and as a percentage confidence interval). According to certain embodiments, GUI 400 likewise comprises a set of controls 421 for adjusting parameters of second visualization 420.

According to various embodiments, GUI 400 further comprises one or more controls 425 through which a user can select which visualizations of sensor data are presented at a given time. In this example, control 425 allows a user to select between seeing the only the feed from the visual camera, only the feed from the thermal camera, and feeds from both of the visual and thermal cameras.

While, in the explanatory example of FIG. 4, GUI 400 has been described with reference to embodiments with two sources of sensor data, other embodiments, with more sensors and more, or different control parameters for controlling multi-sensor multi-layer targeted object recognition are possible and within the contemplated scope of this disclosure.

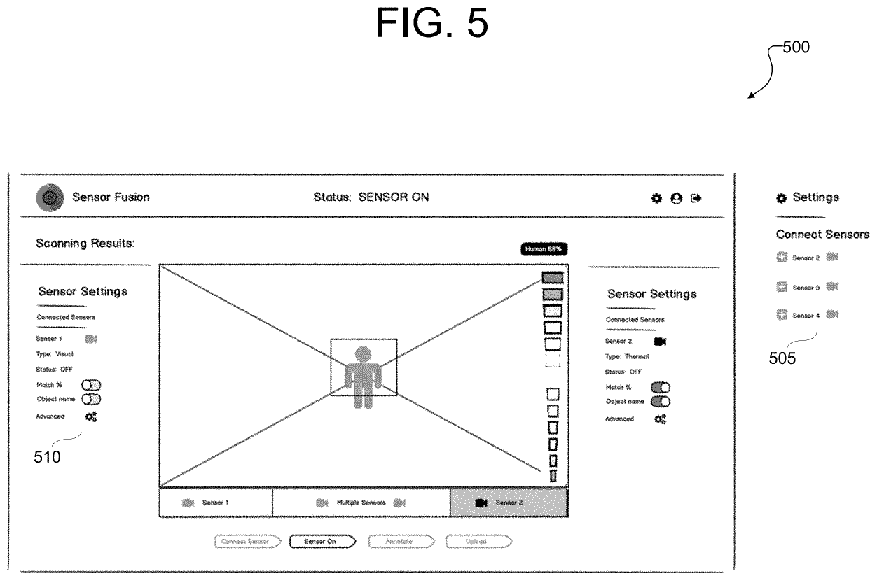

FIG. 5 illustrates a further example of a GUI 500 for providing control inputs and receiving outputs of a targeted object recognition system according to some embodiments of this disclosure. According to certain embodiments, GUI 500 is provided on a display (for example, display 220 in FIG. 2) which is communicatively connected to an apparatus (for example, apparatus 205 in FIG. 2 or apparatus 100 in FIG. 1) implementing multi-sensor targeted object recognition according to various embodiments of this disclosure. In the illustrative example of FIG. 5, the apparatus supporting GUI 400 is communicatively connected to a plurality of sensors, including at least one visual camera, and one thermal camera.

Referring to the non-limiting example of FIG. 5, in certain embodiments, GUI 500 comprises switches, buttons or other mechanisms by which a user can further tune parameters of a multi-sensor, multi-layer targeted object recognition process. As shown in FIG. 5, GUI 500 includes controls 505 by which a user can select and de-select one or more of the sensors as a source of sensor data to be provided to models of an ensemble of models (for example, ensemble 300 in FIG. 3) utilized by the apparatus.

As shown in FIG. 5, GUI 500 can include controls for deeper-level adjustment of the sensor data provided to the ML models comprising the initial, final, and where applicable, intermediate recognition layers. For example, GUI 500 can include one or more “advanced options” menu 510, through which a user can specify further parameters of a multi-sensor, multi-layer targeted object recognition operation. In some embodiments, “advanced options” menu 510 may provide options for selecting models, or the number of recognition layers provided in the ensemble of models used to perform the recognition operation. In this way, certain embodiments according to this disclosure provide not only a high degree of extensibility, but also allow users the granular control to achieve a desired balance between depth of processing and resource consumption.

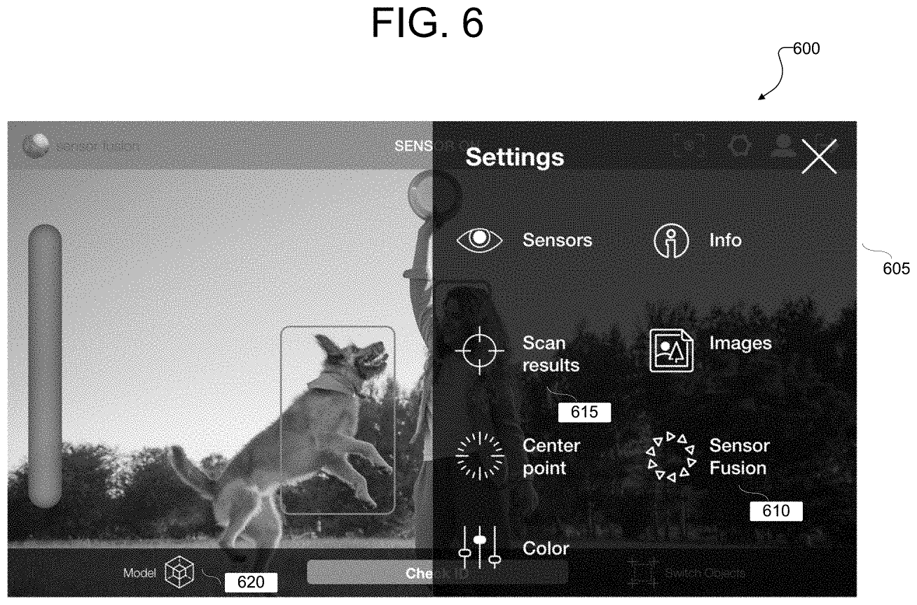

FIG. 6 illustrates a further example of a GUI 600 provided on a display (for example, display 220 in FIG. 2) which is communicatively connected to an apparatus (for example, apparatus 205 in FIG. 2 or apparatus 100 in FIG. 1) implementing multi-sensor targeted object recognition according to various embodiments of this disclosure. In the illustrative example of FIG. 6, the apparatus supporting GUI 400 is communicatively connected to a plurality of sensors.

Referring to the non-limiting example of FIG. 6, GUI 600 comprises one or more “settings” menus 605 to provide users with granular control over the inputs, processing and outputs of a multi-sensor, multi-layer targeted object recognition implemented on an apparatus connected to the display providing GUI 600.

As shown in the illustrative example of FIG. 6, menu 605 provides a control 610 enabling users to control whether a single or multiple sensor recognition is performed. According to certain embodiments, GUI 600 includes a “Scan Results” control 615, through which a user can specify one or more recognition targets. As shown in the explanatory example of FIG. 6, GUI 600 further includes one or more controls 620, by which a user can be provided with an indication of the models comprising one or more of the initial, intermediate and final recognition layers of an ensemble of models used to perform a targeted recognition. In certain embodiments, controls 620 provide users with the ability to select, or deselect models of an ensemble of models used to perform a targeted object recognition. Further, in some embodiments, controls 620 provide an interface by which a user can define parameters of models in the intermediate recognition layer(s), such as which models are to be selected, based on sensor type, prior performance, and the available resolution of each available sensor of the plurality of sensors communicatively connected to the apparatus supporting GUI 600.

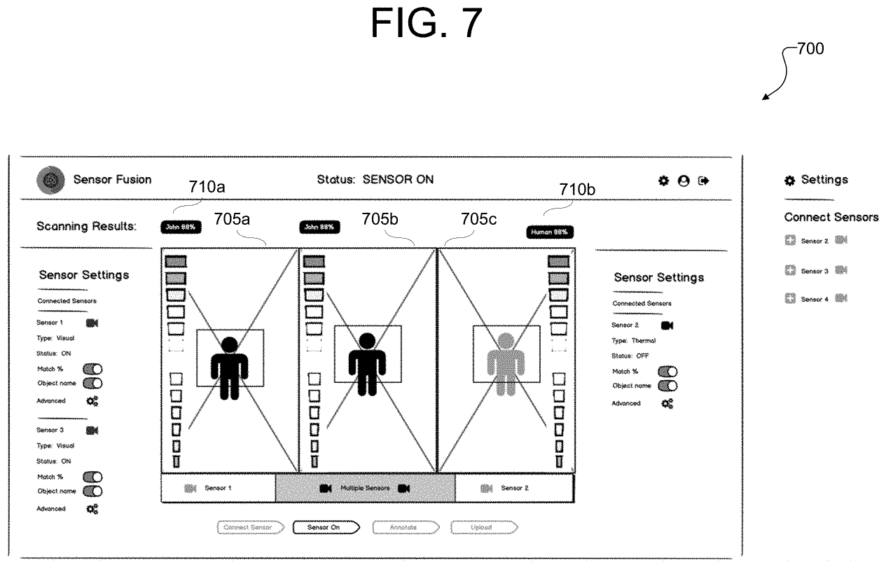

FIG. 7 illustrates a further example of a GUI 700 for providing control inputs and receiving outputs of a multi-sensor, multi-layer object recognition according to various embodiments of this disclosure. As with the examples of GUIs provided in FIGS. 4-6 of this disclosure, GUI 700 can be implemented on a display which is connected to an apparatus (for example, apparatus 100 in FIG. 1) operating as a computing platform for performing a targeted object recognition according to this disclosure. While this disclosure provides examples of GUIs presenting visualizations of sensor data from one or two sensors, the present disclosure is not so limited, and embodiments according to this disclosure include embodiments wherein a GUI provides three or more visualizations of sensor data. In this explanatory example, GUI 700 comprises a first visualization 705a of first sensor data from a first visual camera, a second visualization 705b of second sensor data from a thermal camera; and a third visualization 705c of third sensor data from a second visual camera. Further, as shown in the illustrative example of FIG. 7, GUI 700 can provide visualizations of confidence weighted tags associated with both higher-level attributes, and lower-level attributes. As shown in this example, the outputs provided by GUI 700 include a first confidence weighted label 710a associated with a higher level attribute of the recognition target—specifically, the label “John” with an 88% confidence interval. Further, the outputs provided by GUI 700 include a second confidence weighted label 710b associated with a lower or intermediate level attribute of the recognition target—specifically, the label “human” with an 88% confidence interval. In this way, GUI 700 can provide users with granular, real-time insights as to the effectiveness of sensor/model combinations in the ensemble of models being utilized at the apparatus.

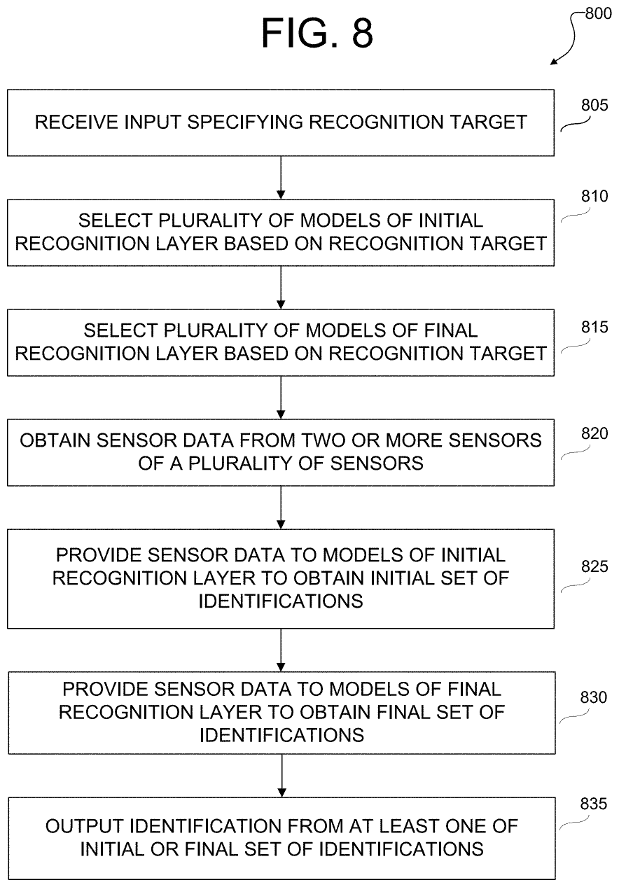

FIG. 8 illustrates operations of one example of a method 800 for implementing multi-sensor multi-layer targeted object recognition according to various embodiments of this disclosure. According to various embodiments, the operations of method 800 can be performed on any suitably configured processing apparatus (for example, apparatus 100 in FIG. 1) in a suitable, multi-sensor system architecture (for example, architecture 200 in FIG. 2).

Referring to the non-limiting example of FIG. 8, at operation 805, an apparatus receives an input specifying a recognition target. According to some embodiments, the recognition target encompasses one or end states of a ML labelling process performed using an ensemble (for example, ensemble 300 in FIG. 3) of ML models configured to form at least an initial and final recognition layer. In certain embodiments, the end states are further associated with a higher, or top-level attribute label in a taxonomy of labels of the end state. Further, in some embodiments, the input specifying the recognition target is provided through a graphical user interface (for example, GUI 400 in FIG. 4, or GUI 600 in FIG. 6) supported by the apparatus.

In some embodiments, at operation 810, the apparatus selects, from a superset of available ML models (for example, models 210 in FIG. 2) of an initial recognition layer (for example, models 305a-d in FIG. 3) based on the recognition target. In some embodiments, the models of the initial recognition layer may be selected solely based on the recognition target (for example, models whose outputs include labels associated with lower-level attributes of the recognition target) or based on the recognition target in combination with one or more contextual or system factors (for example, using a night vision sensor showing an absence of natural light, or avoiding models using power-hungry sensors based on system information showing a present shortage of battery resources).

According to various embodiments, at operation 815, the apparatus selects a plurality of models (for example, models 325a-b) of a final recognition layer based on the recognition target. In some embodiments, the models of the final recognition layer are selected solely based on the recognition target (for example, models whose outputs include labels associated with higher-level attributes of the recognition target). In various embodiments, the models of the final recognition layer are selected based on the recognition target, as well as one or more of a system factor, a contextual factor, or performance of models in the initial recognition layer or intermediate recognition layer(s).

As shown in the non-limiting example of FIG. 8, at operation 820, the apparatus obtains sensor data from two or more sensors (for example, sensors 225a-c) of the plurality of sensors. According to various embodiments, obtaining sensor data is performed after operations 810 and 815, and to conserve resources, the apparatus only obtains sensor data from sensors providing inputs to the selected models. In some embodiments, for example, embodiments where power consumption is not a gating issue, the apparatus continuously obtains sensor data, so that users can gauge the performance of the various sensors, and as, appropriate tune operational parameters of the system (for example, selecting or deselecting sensors through GUI 700 in FIG. 7).

Referring to the illustrative example of FIG. 8, at operation 825, the apparatus provides the obtained sensor data to the selected models of the initial recognition layer to obtain an initial set of identifications. According to various embodiments, the initial set of identifications comprise, for one or more models of the models of the initial recognition layer, an output of the model comprising label (or identification) of an object in the sensor data associating the object with a lower level attribute of the recognition target. In certain embodiments, the identifications of the initial set of identifications comprise confidence weighted labels of sensor data (for example, confidence weighted label 710b in FIG. 7). In certain embodiments, the initial set of identifications obtained at operation 825 may further comprise a composite confidence weighted labels (for example, composite confidence weighted label 310 in FIG. 3).

According to various embodiments, at operation 830, the apparatus provides sensor data to models (for example, models 325a-b in FIG. 3) to obtain a final set of identifications, wherein the final set of identifications comprises identifications of objects in the sensor data associated with at least one higher level attribute and the at least one lower level attribute. In some embodiments, identifications of the final set of identifications comprise confidence weighted labels associated with a higher-level attribute of the recognition target (for example, confidence weighted label 710a in FIG. 7). The final set of identifications may further comprise a composite weighting score, reflecting both the confidence intervals of labeling determinations outputted by models of the final recognition layer, but also confidence intervals of labeling determinations outputted by models of the initial and intermediate layer(s) of the model ensemble performing the targeted object recognition.

Referring to the non-limiting example of FIG. 8, at operation 835, the apparatus outputs an identification (for example, final composite confidence weighted label 330 in FIG. 3) from at least one of the initial or final set of identifications. In certain embodiments, the identification is output through a GUI (for example, GUI 400 in FIG. 4) for controlling and receiving the outputs of the targeted multi-sensor multi-layer recognition. In some embodiments, the identification is output as part of a control instruction to another system. For example, in some embodiments, the apparatus implementing method 800 may be part of a larger system of connected components (for example, a system in which apparatus 100 is part of another system, such as a drone or autonomous vehicle receiving sensor inputs from other drones or data sources). In certain embodiments, the outputted identification obtained at 835 may control a tagging or repair operation. As one example, the output of operation 835 may be a determination of whether a fastener of a structure (for example, a bridge) exhibits recognizable indicia of corrosion or other structural wear, in which case, the identification causes some further operation to occur (for example, spraying paint or rust preventer on the fastener). Still further examples of applications of identifications output by method 800 include controlling a robot or other apparatus to exhibit “pet” like behavior, by following or otherwise interacting specifically with a cohort of individuals or objects which the models implemented by the apparatus have been trained to recognize.

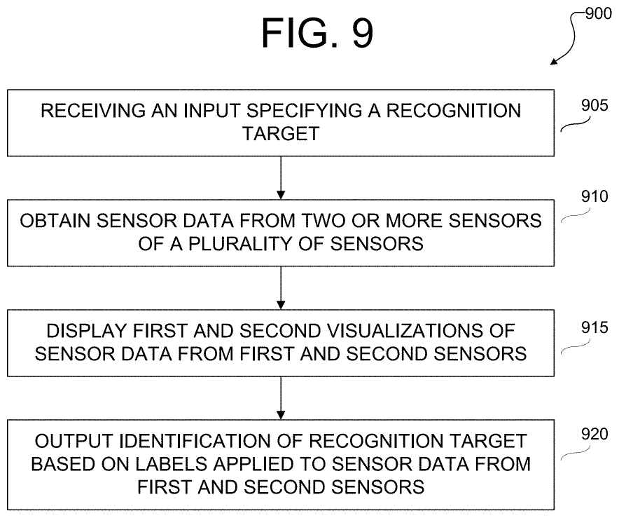

FIG. 9 illustrates operations of one example of a method 900 for providing a graphical user interface (GUI) for controlling and receiving outputs of a multi-sensor targeted object recognition according to various embodiments of this disclosure. In this illustrative example, the operations of method 900 can be performed by a display (for example, display 220 in FIG. 2) supported by an apparatus (for example, apparatus 205 in FIG. 2), that is communicatively connected to a plurality of sensors obtaining sensor data which can be input into ensembles of ML models (for example, ensemble 300 in FIG. 3) running on the apparatus.

Referring to the non-limiting example of FIG. 9, at operation 905, the apparatus receives through a GUI of the apparatus (for example, GUIs 400-700 in FIGS. 4-7) an input specifying a recognition target comprises at least one higher level attribute (for example, the label “John Smith”) of an object (for example, a human being) providing sensor data to a plurality of sensors communicatively connected to the apparatus.

According to some embodiments, at operation 910, the apparatus obtains sensor data from at least two sensors of the plurality of sensors. In some embodiments, the apparatus receives sensor data from all of the connected sensors. In some embodiments, including, without limitation, systems operating under power or processing capacity constraints, the apparatus obtains sensor data from sensors related to the specified recognition target (for example, data from those sensors providing sensor data to relevant models).

As shown in the illustrative example of FIG. 9, at operation 915, the GUI displays a first visualization (for example, first visualization 405 in FIG. 4) of sensor data from a first sensor of the plurality of sensors, and a second visualization (for example, second visualization 410 in FIG. 4) of sensor data from a second sensor of the plurality of sensors.

Further, at operation 920, the GUI outputs an identification of the recognition target based on labels applied to the sensor data from both the first and second sensors. According to some embodiments, the identification may, without limitation, be presented as a bounding box around sensor data, or a visualization of the confidence with which a model has labeled sensor data as comprising the recognition target.

While embodiments according to the present disclosure have been disclosed with reference to examples which output object recognition values, the present disclosure is not so limited, and encompasses embodiments in which the output of a multi-sensor targeted recognition platform comprise control inputs for a vehicle or other mobile system.

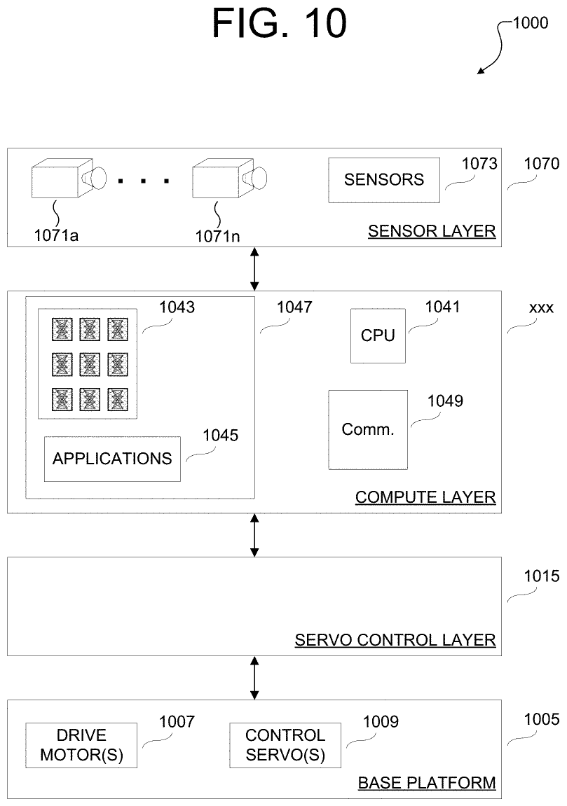

FIG. 10 illustrates an example architecture 1000 of a modular, autonomous vehicle platform according to various embodiments of this disclosure. As will be discussed herein, certain embodiments according to this disclosure leverage the expansive object and facial recognition capabilities afforded by using layered ensembles of machine learning models to perform object-based navigation and spatial reckoning. In this way, certain autonomous vehicle platforms according to this disclosure can navigate in environments without complete reliance on external positioning signals (for example, GPS or GNSS signals) or where the precise locations of waypoints, obstacles and objects of navigational interest are unknown or have changed.

Referring to the non-limiting example of FIG. 10, architecture 1000 comprises a base mobility platform 1005, which may be any motorized vehicle which can, at a minimum, carry and power the additional layers (i.e., servo control layer 1015, compute layer 1040, and sensor layer 1070) of architecture 1000, and whose travel (i.e., direction and speed) can be controlled in real-time through digital signals provided from a processor to one or more control elements of the drivetrain of base mobility platform 1005. In certain embodiments (including some test platforms and proof of concept designs), a SEGWAY® has been used as a base mobility platform 1005. In other embodiments, base mobility platform 1005 could be a remote controlled (RC) car, a “hoverboard” style mobility device, an automobile, or a flying drone.

As shown in FIG. 10, in some embodiments, base mobility platform 1005 comprises one or more drive motor(s) 1007, which provide locomotive power through one or more interfaces (for example, tires, tracks, propellers, etc.) for pushing against the operating environment of base mobility platform 1005. In some embodiments, drive motor(s) 1007 may be stepper motors, whose motion can be controlled at an angular level in response to control inputs from a processor. In some embodiments, drive motor(s) 1007, drive motor(s) are not stepper motors, and are controlled by changing the polarity and amplitude of a driving current to the motors. According to some embodiments, base mobility platform 1005 further comprises one or more control servo motor(s) 1009 for actuating one or more control mechanisms (for example, mechanisms for changing the pitch of a propellor or the direction of a wheel) of base mobility platform 10005 in response to a control signal received from a processor. According to various embodiments, control servo motor(s) 1009 may be one or more of linear servos, continuous rotation servos, or positional rotation servos, or combinations thereof.

Referring to the non-limiting example of FIG. 10, base mobility platform 1005 is connected to compute layer 1040 through a servo control layer 1014. According to various embodiments, servo control layer 1015 handles translating control inputs from compute layer 1040 to base mobility platform 1005. In some embodiments, the clock speeds for controlling drive motor(s) 1007 and control servo motor(s) 1009 differ from the clock speeds of the processor(s) 1041 of compute layer 1040. Additionally, in some embodiments, control inputs from compute layer 1040 may require further encoding before they can be used by drive motor(s) 1007 and control servo motor(s) 1009. Accordingly, servo control layer 1015 performs the additional synchronization and encoding to ensure that control inputs from compute layer 1040 can be consumed and correctly utilized by the driving components of base mobility platform 1005. In some embodiments, servo control layer 1015 is provided by one or more controllers of base mobility platform 1005. In some embodiments, servo control layer 1015 may be provided as a middleware application executing on compute layer 1040.

Referring to the illustrative example of FIG. 10, architecture 1000 further comprises a sensor layer 1070, which is communicatively connected to compute layer 1040. According to various embodiments, sensor layer 1070 comprises one or more visual cameras 1071a through 1071n, which are disposed on base mobility platform 1005, and provide a view of the operating environment of base mobility platform 1005. Visual camera 1071a may, in some embodiments, be a camera using a complementary MOSFET (C-MOS) sensor, which outputs frames of image data from each pixel of the sensor. In some embodiments, visual camera 1071a may be a dynamic vision sensor (DVS), which outputs a stream of events corresponding to changes in brightness at pixels covering a portion of a field of view.

Referring to the non-limiting example of FIG. 10, sensor layer 1070 may further comprise additional sensors 1073, through which the system embodying architecture 1000 obtains a view of its operating environment, from which it can determine its spatial relationship to physical objects in its operating environment at a level suitable for moving and navigating within the operating environment. For example, additional sensors 1073 may comprise one or more of a LIDAR sensor or a time of flight (TOF) sensor, from which the range and distance information of objects within the field of view of visual cameras 1071a-1071n can be determined. Further, in some embodiments, additional sensors 1073 comprise sensors external to base mobility platform 1005 (for example, a camera mounted at a high vantage point, or visual cameras on another base mobility platform embodying a separate instance of architecture 1000.

As shown in the explanatory example of FIG. 10, base mobility platform 1005 and sensor layer 1070 are communicatively connected to compute layer 1040. According to certain embodiments, compute layer 1040 comprises one or more processors 1041 (for example, main processor 140 in FIG. 1), which are configured to pre-process outputs from sensor layer 1070 and provide them as features to one or more object recognition models of an ensemble 1043 (for example, ensemble 300 in FIG. 3) of object recognition models supported by processor(s) 1041. According to various embodiments, ensemble 1043 and one or navigation applications 1045 are maintained in a non-transitory memory 1047 of compute layer 1040. Non-transitory memory 1047 may, in some embodiments, be a solid state drive (SSD) or other persistent storage medium accessible to CPU 1041. Computer layer 1040 also comprises a communications interface (for example, communications unit 110 in FIG. 1), such as a baseband processor or other wireless communications interface providing a wireless connection between compute layer 1049 and external devices (such as external sensors or other instances of architecture 1000).

According to various embodiments, non-transitory memory 1047 comprises one or more navigation applications 1045. In some embodiments, compute layer 1040 is configured to receive sensor data from sensor layer 1070 and perform targeted objected recognition (for example, as described with reference to the embodiments shown in FIGS. 3 and 8 of this disclosure, of objects in the field of view of the sensors of sensor layer 1070. Navigation applications 1045 compare the visual data from sensor layer 1070 against reference views of the identified object to determine a perspective vector representing the position of base mobility platform 1005 relative to the identified object. By generating two or more such perspective vectors, navigation application 1045 can triangulate on its position within the operating environment. In contrast to, for example, navigation based on comparing a pre-generated map against a positioning signal (for example, a GPS or GNSS signal), embodiments according to the present invention are not susceptible to the effects of losing a positioning signal, or discrepancies between the mapped and actual locations of points of interest. Further, in contrast visual-inertial simultaneous location and mapping (“V-SLAM”) systems, embodiments according to the present disclosure can navigate and generate an understanding of their location within an operating environment without reliance on data from inertial sensors (i.e., while standing still). For certain applications, such as military applications, where conditions may require periods of sustained motionlessness, this may be an operational advantage.

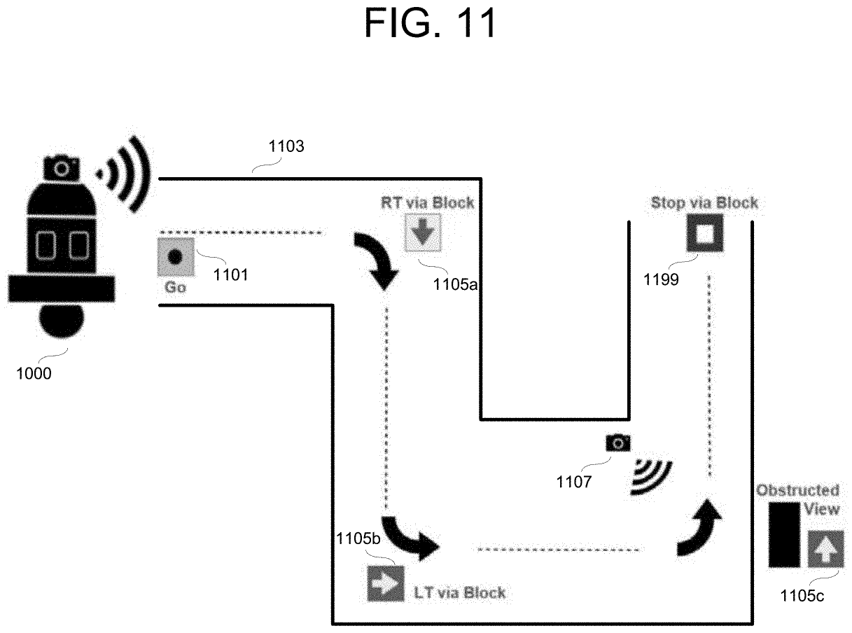

FIG. 11 illustrates an example of an autonomous vehicle (for example, a vehicle embodying architecture 1000 in FIG. 10) performing object-recognition based navigation according to various embodiments of this disclosure negotiating a course.

Referring to the explanatory example of FIG. 11, an autonomous vehicle 1100 according to various embodiments of this disclosure (for example, a vehicle embodying architecture 1000 in FIG. 10) is shown in the figure. Autonomous vehicle 1100 has been programmed to navigate from a starting point 1101 to a finish point 1199 along a predetermined path 1103 delineated by a series of waypoints, which are recognized by providing sensor data (for example, image data and/or audio data) to an ensemble of recognition models (for example, ensemble 300 in FIG. 3). While it would be possible to configure autonomous vehicle 1100 to navigate from starting point 1101 to finish point 1199 according to inertial (for example, travel x meters along bearing y, then travel n meters along bearing z) or geospatial coordinates, these approaches are dependent on autonomous vehicle 1100 being able to either maintain contact with a source of positional data (for example, a GPS satellite) or accurately record distance and direction traveled. In many real-world operating conditions, such as heavy cloud cover, or slick or damaged operating surfaces, these predicates for performance cannot reliably be assumed. According to various embodiments, autonomous vehicle 1100 is configured to navigate predetermined path 1103 by recognizing object waypoints 1105a-1105c based on sensor data provided to an ensemble of models and navigating from one waypoint to the next. In this way, the performance of autonomous vehicle 1100 (as expressed by its ability to successfully navigate from starting point 1101 to finish point 1199) is less susceptible to inaccuracies in a map or the confounding effects of conditions making accurate measurement of distance travelled impossible. Instead, object waypoints 1105a-1105c define when autonomous vehicle needs to make gross navigational maneuvers (for example, a sharp right turn). Smaller navigational maneuvers can be determined dynamically, as autonomous vehicle 1100 recognizes and navigates towards the next object waypoint. Further, as discussed with reference to FIG. 10, in certain embodiments, autonomous vehicle 1100 may be communicatively connected to one or more external visual cameras 1107 (for example, standalone cameras, or cameras that are part of other autonomous vehicles) and configured to receive visual camera data from another camera. In this way, the position of autonomous vehicle 1100 can still be serviceably determined based on visual data from the external camera, even if the object waypoint (for example, third object waypoint 1105c) is not presently visible.

Examples of methods for performing multi-sensor targeted object recognition according to this disclosure include methods comprising receiving an input specifying a recognition target, wherein the recognition target comprises at least one higher level attribute of an object providing sensor data. The method further includes selecting a plurality of models of an initial recognition layer based on the recognition target, wherein each model of the initial recognition layer is configured to associate data of a specified sensor with at least one lower level attribute, selecting a plurality of models of a final recognition layer based on the recognition target, wherein each model of the final recognition layer is configured to associate data of a specified sensor with the at least one higher level attribute, obtaining sensor data from two or more sensors of the plurality of sensors, providing the sensor data to the plurality of models of the initial recognition layer to obtain an initial set of identifications, wherein the initial set of identifications comprises identifications of objects associated with the at least one lower level attribute, providing sensor data to the plurality of models of the final recognition layer to obtain a final set of identifications, wherein the final set of identifications comprises identifications of objects associated with the at least one higher level attribute and the at least one lower level attribute, and outputting an identification from at least one of the initial set of identifications or the final set of identifications.

Examples of methods for performing multi-sensor targeted object recognition according to this disclosure include methods wherein the plurality of sensors comprises at least one of a complementary metal oxide semiconductor (CMOS) image sensor, a dynamic vision sensor (DVS), an infrared (IR) imaging sensor, a light detection and ranging (LIDAR) scanner, an ultraviolet (UV) imaging sensor, a time of flight (TOF) sensor, a stereoscopic visual or thermal camera, or an acoustic sensor.

Examples of methods for performing multi-sensor targeted object recognition according to this disclosure include methods further comprising for each identification of the initial set of identifications, determining a confidence interval of the identification of objects associated with the at least one lower level attribute and selecting the plurality of models of the final recognition layer based in part on the determined confidence intervals.

Examples of methods for performing multi-sensor targeted object recognition according to this disclosure include methods comprising selecting a plurality of models of an intermediate recognition layer based on the recognition target, wherein each model of the intermediate recognition layer is configured to associate data of a specified sensor with at least one intermediate level attribute and providing sensor data to the plurality of models of the intermediate recognition layer to obtain an intermediate set of identifications, wherein the intermediate set of identifications comprises identifications of objects associated with the at least one intermediate level attribute.

Examples of methods for performing multi-sensor targeted object recognition according to this disclosure include methods comprising for each identification of the initial set of identifications, determining a confidence interval of the identification of objects associated with the at least one lower level attribute and selecting the plurality of models of the intermediate recognition layer based in part on the determined confidence intervals.

Examples of methods for performing multi-sensor targeted object recognition according to this disclosure include methods wherein the apparatus is an edge device.

Examples of methods for performing multi-sensor targeted object recognition according to this disclosure include methods comprising performing a parallax correction of sensor data of the plurality of sensors.

Examples of methods of controlling a multi-sensor targeted object recognition according to this disclosure include methods comprising receiving, via a graphical user interface of an apparatus communicatively connected to a plurality of sensors, an input specifying a recognition target, wherein the recognition target comprises at least one higher level attribute of an object providing sensor data, obtaining, by the apparatus, sensor data from two or more sensors of the plurality of sensors, and displaying, at the graphical user interface, a first visualization of sensor data from a first sensor of the plurality of sensors, and a second visualization of sensor data from a second sensor of the plurality of sensors, wherein a field of view of the first visualization of sensor data overlaps with a field of view of the second visualization of sensor data.

Examples of methods of controlling a multi-sensor targeted object recognition according to this disclosure include methods comprising displaying, in or around the first visualization of sensor data, a first visualization of a confidence score associated with the at least one higher level attribute.

Examples of methods of controlling a multi-sensor targeted object recognition according to this disclosure include methods comprising displaying, in or around the second visualization of sensor data, a second visualization of a confidence score associated with the higher level attribute.

Examples of methods of controlling a multi-sensor targeted object recognition according to this disclosure include methods comprising displaying, at the graphical user interface, a visualization of a composite confidence score associated with the higher level attribute, wherein the composite confidence score is based on data from the first sensor and the second sensor.

Examples of methods of controlling a multi-sensor targeted object recognition according to this disclosure include methods comprising receiving, via the graphical user interface, an input selecting or deselecting a sensor of the plurality of sensors as the first sensor.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A method for performing multi-sensor targeted object recognition, the method comprising:
at an apparatus communicatively connected to a plurality of sensors, receiving an input specifying a recognition target, wherein the recognition target comprises at least one higher level attribute of an object providing sensor data;
selecting a plurality of models of an initial recognition layer based on the recognition target, wherein each model of the initial recognition layer is configured to associate data of a specified sensor with at least one lower level attribute;
selecting a plurality of models of a final recognition layer based on the recognition target, wherein each model of the final recognition layer is configured to associate data of a specified sensor with the at least one higher level attribute;
obtaining sensor data from two or more sensors of the plurality of sensors;
providing the sensor data to the plurality of models of the initial recognition layer to obtain an initial set of identifications, wherein the initial set of identifications comprises identifications of objects associated with the at least one lower level attribute;
providing sensor data to the plurality of models of the final recognition layer to obtain a final set of identifications, wherein the final set of identifications comprises identifications of objects associated with the at least one higher level attribute and the at least one lower level attribute; and
outputting an identification from at least one of the initial set of identifications or the final set of identifications.

2. The method of claim 1, wherein the plurality of sensors comprises at least one of a complementary metal oxide semiconductor (CMOS) image sensor, a dynamic vision sensor (DVS), an infrared (IR) imaging sensor, a light detection and ranging (LIDAR) scanner, an ultraviolet (UV) imaging sensor, a time of flight (TOF) sensor, a stereoscopic visual or thermal camera, or an acoustic sensor.

3. The method of claim 1, further comprising:
for each identification of the initial set of identifications, determining a confidence interval of the identification of objects associated with the at least one lower level attribute; and
selecting the plurality of models of the final recognition layer based in part on the determined confidence intervals.

4. The method of claim 1, further comprising:
selecting a plurality of models of an intermediate recognition layer based on the recognition target, wherein each model of the intermediate recognition layer is configured to associate data of a specified sensor with at least one intermediate level attribute; and
providing sensor data to the plurality of models of the intermediate recognition layer to obtain an intermediate set of identifications, wherein the intermediate set of identifications comprises identifications of objects associated with the at least one intermediate level attribute.

5. The method of claim 4, further comprising:
for each identification of the initial set of identifications, determining a confidence interval of the identification of objects associated with the at least one lower level attribute; and
selecting the plurality of models of the intermediate recognition layer based in part on the determined confidence intervals.

6. The method of claim 1, wherein the apparatus is an edge device.

7. The method of claim 1, further comprising:
performing a parallax correction of sensor data of the plurality of sensors.

8. A method of controlling a multi-sensor targeted object recognition, the method comprising;
receiving, via a user interface (UI) of an apparatus communicatively connected to a plurality of sensors, an input specifying a recognition target, wherein the recognition target comprises at least one higher level attribute of an object providing sensor data;
obtaining, by the apparatus, sensor data from two or more sensors of the plurality of sensors; and
displaying, at the user interface, a first visualization of sensor data from a first sensor of the plurality of sensors, and a second visualization of sensor data from a second sensor of the plurality of sensors, wherein a field of view of the first visualization of sensor data overlaps with a field of view of the second visualization of sensor data.

9. The method of claim 8, further comprising:
displaying, in or around the first visualization of sensor data, a first visualization of a confidence score associated with the at least one higher level attribute.

10. The method of claim 9, further comprising:
displaying, in or around the second visualization of sensor data, a second visualization of a confidence score associated with the higher level attribute.

11. The method of claim 8, further comprising:
displaying, at the user interface, a visualization of a composite confidence score associated with the higher level attribute, wherein the composite confidence score is based on data from the first sensor and the second sensor.

12. The method of claim 8, further comprising:
receiving, via the UI, an input selecting or deselecting a sensor of the plurality of sensors as the first sensor.

13. The method of claim 8, wherein the plurality of sensors comprise:
at least one of a complementary metal oxide semiconductor (CMOS) image sensor, a dynamic vision sensor (DVS), an infrared (IR) imaging sensor, a light detection and ranging (LIDAR) scanner, an ultraviolet (UV) imaging sensor, or a microphone.

14. The method of claim 8, wherein the apparatus connected to the plurality of sensors is an edge device.

15. An apparatus comprising:
a processor;
an input/output interface (I/O IF) communicatively connecting the processor to a plurality of sensors; and
a memory containing instructions, which, when executed by the processor, cause the apparatus to:
receive an input specifying a recognition target, wherein the recognition target comprises at least one higher level attribute of an object providing sensor data;
select a plurality of models of an initial recognition layer based on the recognition target, wherein each model of the initial recognition layer is configured to associate data of a specified sensor with at least one lower level attribute;
select a plurality of models of a final recognition layer based on the recognition target, wherein each model of the final recognition layer is configured to associate data of a specified sensor with the at least one higher level attribute;
obtain sensor data from two or more sensors of the plurality of sensors;
provide the sensor data to the plurality of models of the initial recognition layer to obtain an initial set of identifications, wherein the initial set of identifications comprises identifications of objects associated with the at least one lower level attribute;
provide sensor data to the plurality of models of the final recognition layer to obtain a final set of identifications, wherein the final set of identifications comprises identifications of objects associated with the at least one higher level attribute and the at least one lower level attribute; and
output an identification from at least one of the initial set of identifications or the final set of identifications.

16. The apparatus of claim 15, wherein the plurality of sensors comprises at least one of a complementary metal oxide semiconductor (CMOS) image sensor, a dynamic vision sensor (DVS), an infrared (IR) imaging sensor, a light detection and ranging (LIDAR) scanner, an ultraviolet (UV) imaging sensor, a time of flight (TOF) sensor, a stereoscopic visual or thermal camera, or an acoustic sensor.

17. The apparatus of claim 15, wherein the memory further contains instructions, which, when executed by the processor, cause the apparatus to:
for each identification of the initial set of identifications, determine a confidence interval of the identification of objects associated with the at least one lower level attribute; and
select the plurality of models of the final recognition layer based in part on the determined confidence intervals.

18. The apparatus of claim 15, wherein the memory further contains instructions, which, when executed by the processor, cause the apparatus to:
select a plurality of models of an intermediate recognition layer based on the recognition target, wherein each model of the intermediate recognition layer is configured to associate data of a specified sensor with at least one intermediate level attribute; and
provide sensor data to the plurality of models of the intermediate recognition layer to obtain an intermediate set of identifications, wherein the intermediate set of identifications comprises identifications of objects associated with the at least one intermediate level attribute.

19. The apparatus of claim 18, wherein the memory further contains instructions, which, when executed by the processor, cause the apparatus to:
for each identification of the initial set of identifications, determine a confidence interval of the identification of objects associated with the at least one lower level attribute; and
select the plurality of models of the intermediate recognition layer based in part on the determined confidence intervals.

20. The apparatus of claim 15, wherein the apparatus is an edge device.

21. The apparatus of claim 15, wherein the memory further contains instructions, which, when executed by the processor, cause the apparatus to perform a parallax correction of sensor data of the plurality of sensors.

22. An apparatus comprising:
a processor;
an input/output interface (I/O IF) communicatively connecting the processor to a plurality of sensors and a display for providing a graphical user interface; and
a memory containing instructions, which, when executed by the processor, cause the apparatus to:
receive, via the graphical user interface, an input specifying a recognition target, wherein the recognition target comprises at least one higher level attribute of an object providing sensor data;
obtain sensor data from two or more sensors of the plurality of sensors; and
display, at the graphical user interface, a first visualization of sensor data from a first sensor of the plurality of sensors, and a second visualization of sensor data from a second sensor of the plurality of sensors, wherein a field of view of the first visualization of sensor data overlaps with a field of view of the second visualization of sensor data.

23. The apparatus of claim 22, wherein the memory further contains instructions, which, when executed by the processor, cause the apparatus to display, in or around the first visualization of sensor data, a first visualization of a confidence score associated with the at least one higher level attribute.

24. The apparatus of claim 23, wherein the memory further contains instructions, which, when executed by the processor, cause the apparatus to display, in or around the second visualization of sensor data, a second visualization of a confidence score associated with the higher level attribute.

25. The apparatus of claim 22, wherein the memory further contains instructions, which, when executed by the processor, cause the apparatus to display, at the graphical user interface, a visualization of a composite confidence score associated with the higher level attribute, wherein the composite confidence score is based on data from the first sensor and the second sensor.

26. The apparatus of claim 22, wherein the memory further contains instructions, which, when executed by the processor, cause the apparatus to receive, via the graphical user interface, an input selecting or deselecting a sensor of the plurality of sensors as the first sensor.

27. The apparatus of claim 22, wherein the plurality of sensors comprise at least one of:
a complementary metal oxide semiconductor (CMOS) image sensor, a dynamic vision sensor (DVS), an infrared (IR) imaging sensor, a light detection and ranging (LIDAR) scanner, an ultraviolet (UV) imaging sensor, a time of flight (TOF) sensor, a stereoscopic visual or thermal camera, or an acoustic sensor.

28. The apparatus of claim 22, wherein the apparatus is an edge device.

29. A non-transitory computer-readable medium containing instructions, which when executed by a processor, cause an apparatus comprising the processor, an input/output interface (I/O IF) communicatively connecting the processor to a plurality of sensors, to:
receive an input specifying a recognition target, wherein the recognition target comprises at least one higher level attribute of an object providing sensor data;
select a plurality of models of an initial recognition layer based on the recognition target, wherein each model of the initial recognition layer is configured to associate data of a specified sensor with at least one lower level attribute;
select a plurality of models of a final recognition layer based on the recognition target, wherein each model of the final recognition layer is configured to associate data of a specified sensor with the at least one higher level attribute;
obtain sensor data from two or more sensors of the plurality of sensors;
provide the sensor data to the plurality of models of the initial recognition layer to obtain an initial set of identifications, wherein the initial set of identifications comprises identifications of objects associated with the at least one lower level attribute;
provide sensor data to the plurality of models of the final recognition layer to obtain a final set of identifications, wherein the final set of identifications comprises identifications of objects associated with the at least one higher level attribute and the at least one lower level attribute; and
output an identification from at least one of the initial set of identifications or the final set of identifications.

30. The non-transitory, computer-readable medium of claim 29, wherein the plurality of sensors comprises at least one of a complementary metal oxide semiconductor (CMOS) image sensor, a dynamic vision sensor (DVS), an infrared (IR) imaging sensor, a light detection and ranging (LIDAR) scanner, an ultraviolet (UV) imaging sensor, a time of flight (TOF) sensor, a stereoscopic visual or thermal camera, or an acoustic sensor.

31. The non-transitory, computer-readable medium of claim 29, further containing instructions, which, when executed by the processor, cause the apparatus to:
for each identification of the initial set of identifications, determine a confidence interval of the identification of objects associated with the at least one lower level attribute; and
select the plurality of models of the final recognition layer based in part on the determined confidence intervals.

32. The non-transitory, computer-readable medium of claim 29, further containing instructions, which, when executed by the processor, cause the apparatus to:
select a plurality of models of an intermediate recognition layer based on the recognition target, wherein each model of the intermediate recognition layer is configured to associate data of a specified sensor with at least one intermediate level attribute; and
provide sensor data to the plurality of models of the intermediate recognition layer to obtain an intermediate set of identifications, wherein the intermediate set of identifications comprises identifications of objects associated with the at least one intermediate level attribute.

33. The non-transitory, computer-readable medium of claim 32, further containing instructions, which, when executed by the processor, cause the apparatus to:
for each identification of the initial set of identifications, determine a confidence interval of the identification of objects associated with the at least one lower level attribute; and
select the plurality of models of the intermediate recognition layer based in part on the determined confidence intervals.

34. The non-transitory, computer-readable medium of claim 29, wherein the apparatus is an edge device.

35. The non-transitory, computer-readable medium of claim 29, further containing instructions, which, when executed by the processor, cause the apparatus to a parallax correction of sensor data of the plurality of sensors.

36. A non-transitory computer-readable medium containing instructions, which when executed by a processor of an apparatus comprising an input/output interface (I/O IF) communicatively connecting the processor to a plurality of sensors and a display for providing a graphical user interface, cause the apparatus to:
receive, via the graphical user interface, an input specifying a recognition target, wherein the recognition target comprises at least one higher level attribute of an object providing sensor data;
obtain sensor data from two or more sensors of the plurality of sensors; and
display, at the graphical user interface, a first visualization of sensor data from a first sensor of the plurality of sensors, and a second visualization of sensor data from a second sensor of the plurality of sensors, wherein a field of view of the first visualization of sensor data overlaps with a field of view of the second visualization of sensor data.

37. The non-transitory, computer-readable medium of claim 36, further containing instructions, which when executed by the processor, cause the apparatus to display, in or around the first visualization of sensor data, a first visualization of a confidence score associated with the at least one higher level attribute.

38. The non-transitory, computer-readable medium of claim 37, further containing instructions, which when executed by the processor, cause the apparatus to display, in or around the second visualization of sensor data, a second visualization of a confidence score associated with the at least one higher level attribute.

39. The non-transitory, computer-readable medium of claim 36, further containing instructions, which when executed by the processor, cause the apparatus to display, at the graphical user interface, a visualization of a composite confidence score associated with the higher level attribute, wherein the composite confidence score is based on data from the first sensor and the second sensor.

40. The non-transitory, computer-readable medium of claim 36, further containing instructions, which when executed by the processor, cause the apparatus to receive, via the graphical user interface, an input selecting or deselecting a sensor of the plurality of sensors as the first sensor.

41. The non-transitory, computer-readable medium of claim 36, wherein the plurality of sensors comprise at least one of:
a complementary metal oxide semiconductor (CMOS) image sensor, a dynamic vision sensor (DVS), an infrared (IR) imaging sensor, a light detection and ranging (LIDAR) scanner, an ultraviolet (UV) imaging sensor, a time of flight (TOF) sensor, a stereoscopic visual or thermal camera, or an acoustic sensor.

42. The non-transitory, computer-readable medium of claim 36, wherein the apparatus is an edge device.
